(19) United States
(12) Patent Application Publication
(10) Pub. No.: US 2005/0108600 A1
(43) Pub. Date: May 19, 2005

(54) Process and device for testing a serializer circuit arrangement and process and device for testing a deserializer circuit arrangement

(75) Inventor: Javier Arguelles, Munchen (DE)

Correspondence Address: Scott B. Stahl;Jackson Walker LLP, 2435 N. Central Expwy., Ste. 600, Richardson, TX, 75080, US

(73) Assignee: Infineon Technologies AG

(21) Appl. No.: 10/717,214

(22) Filed: Nov. 19, 2003

(51) Int. Cl. G06F 11/00

(52) U.S. Cl. 714/701

(57) ABSTRACT

A process and a device are proposed for testing a serializer and deserializer circuit arrangement, where to control the test sequence a simple digital interface is used. To test the serializer circuit arrangement firstly the quality of a multiphase clock signal of the serializer circuit arrangement and secondly the ability to transmit a preset bit pattern are tested. To test the deserializer circuit arrangement the quality of the multiphase clock signal and the quality of a data eye obtained during clock and data recovery are tested together with the quality of the clock recovery.

### BACKGROUND

The present invention relates to a process and a device for testing a serializer circuit arrangement and a deserializer circuit arrangement such as are used in transceiver modules, in particular high speed communication modules.

Conventional transceiver modules have a receiver section and a transmitter section. An example of a conventional transceiver module of this kind is shown in FIG. 1.

As is clear from FIG. 1, the transceiver module 1 has a receiver section 3 which demultiplexes a received serial datastream DATAIN into a parallel datastream DATA2 and supplies it to a digital circuit core 4 of the transceiver module 1. In the case of an optical transceiver module 1, the receiver section 3 can, for example, have a photo diode to convert the received optical datastream DATAIN into a current which is finally converted by use of a transimpedance amplifier into logic levels, that is, a digital signal. In addition, the receiver section 3 has a circuit for clock and data recovery that extracts the clock signal used for transmission from the received datastream DATAIN and uses the recovered clock signal to sample the received datastream DATAIN in order to recover the data on the basis of this clock signal and demultiplex it to the original parallel data channels in DATA2. The circuit arrangement used for this in the receiver section 3 is known, because of its functionality, as a deserializer circuit arrangement. The demultiplexing to the parallel datastream DATA2 takes place using a multiphase clock signal CLK, which in particular can comprise four equidistant clock phases each with a phase difference of 90° and is preferably derived from the recovered clock signal.

The transmitter section 2 receives a parallel datastream DATA1 from the digital circuit core 4 of the transceiver module 1 and converts it into a serial datastream DATAOUT, that is, the parallel datastream DATA1 is multiplexed into the serial datastream DATAOUT, which has a higher data rate than the parallel datastream DATA1. The resulting datastream is supplied in the case of an optical transceiver module 1 to a laser driver which converts the serial datastream DATAOUT into a corresponding optical serial datastream and transmits this to a receiver. The circuit arrangement used in the transmission section 2, because of its functionality, is known as a serializer circuit arrangement, where to convert the parallel datastream DATA1 into the serial datastream DATAOUT again a multiphase clock signal is used that can correspond to the multiphase clock signal CLK of the receiver section 3 or the deserializer circuit arrangement implemented therein.

Modern technology allows the implementation of serializer and deserializer circuit arrangements, known jointly under the abbreviation SERDES, together with a circuit section for digital processing of the required signals, on a common monolithic substrate. A key element required for successful implementation of the SERDES functionality is a phase control circuit (“phase locked loop”, PLL) 28. SERDES circuits require a phase control circuit and a clock distribution tree to provide a valid clock to different circuit blocks within the design. The integrity of this clock is a must for the SERDES performance. The clock in general can be routed using two phases or four phases. The phase control circuit thus generates a multiphase clock signal on the basis of the clock signal recovered from the serial datastream DATAIN, where the phases of the multiphase clock signal CLK are locked in particular against the recovered clock signal by the phase control circuit, that is, the phases of the multiphase clock signal CLK are adjusted continuously by the phase control circuit to the clock signal recovered. The output clock signal of the phase control circuit follows the recovered clock phase (rising and falling clock edges occur at the same time). The multiphase clock signal CLK as described is used not only for data recovery but also for data transmission. Thus, the multiphase clock signal is used to sample the incoming data DATAIN and also to serialize the data DATA1 to be transmitted.

Modern high speed communication circuits must support data rates in the region of several Gigabits per second (Gbps) with bit error rates (BER) in the region of 10⁻¹². In order to guarantee these performance qualities, an extensive test of the SERDES circuit arrangements implemented therein is unavoidable.

Conventionally, testing of SERDES circuit arrangements of this kind is possible only with a complex and consequently cost-intensive test equipment. In addition, an extensive test requires a multiplicity of different test processes, which are consequently relatively time-consuming and which increase the costs associated with the SERDES circuit arrangement to be tested or the corresponding module.

Conventionally, external test devices are used that monitor the quality of the implemented SERDES circuit arrangements. To a certain extent, the test functionality of these external test devices can be transferred to the SERDES circuit arrangements in order to allow an integrated self test, where however the test approach remains the same in principle and thus still entails a relatively time-consuming test process. In addition, for such a self-test functionality, the required chip or silicon area of the module concerned must be enlarged.

According to the state of the art, bit error rate testing is performed in order to assess the SERDES performance. Bit error rate testing devices can be implemented on clip, the required test time however still being relatively high.

### SUMMARY

One embodiment of the present invention is a process and a correspondingly designed device for testing such SERDES circuit arrangements, where the SERDES circuit arrangements can be tested for quality reliably, simply and economically. In one embodiment of the present invention a process and a device are proposed for testing SERDES circuit arrangements without the need of cost-intensive external test equipment.

One embodiment of the present invention proposes a new test concept with which a similar test quality can be achieved to conventional test devices, wherein however only slower and less expensive test devices need be used. Irrespective of this, the entire test can be performed directly on chip and many orders of magnitude faster than in conventional test devices. According to one embodiment of the invention, high frequency signals are used as test signals, where the test sequence is controlled by an external test device via a simple digital test interface. The test is performed at wafer level of the module to be tested so as to locate a fault as early as possible. However, further tests at package level are also possible. Advantageously, only a few additional connections are required that are not accessible at package level so that these connections do not cause any additional package costs.

According to one embodiment of the invention, the test of a serializer circuit arrangement comprises testing the quality of a multiphase clock signal used by the serializer circuit arrangement and testing the ability of the serializer circuit arrangement to transmit a prespecified bit pattern correctly. The main functional test of the serializer circuit arrangement involves bit error rate testing by using a simplified test for locating causes for bit errors that involve testing the integrity of the sampling multiphase clock signal and checking timing errors.

To test the multiphase clock signal, using a phase offset monitor a phase offset between two clock phases of the multiphase clock signal can be detected and evaluated, where the phase offset monitor in particular is formed by a combination of a mixer with a low pass filter and a voltage/current converter.

To test the ability of the serializer circuit arrangement to transmit the prespecified digital bit or signal pattern, a repetitive digital signal pattern in the form of a high transition density data stream is supplied to the serializer circuit arrangement in order to test timing errors, and a phase offset adjusted to this between a phase of the serial datastream, which is dependent thereon and generated by the serializer circuit arrangement, and one of the clock phases of the multiphase clock signal is evaluated, wherein again a phase offset monitor of the type described above can be used. For example, the prespecified repetitive digital signal pattern can be an “010101 . . . ” pattern. Also, however, it can be a digital signal pattern of lower frequency such as for example “00110011 . . . ”. In this case, the clock phase signal to be compared with the phase of the resulting serial datastream must be divided by a divisor with a division factor 1/2 before it is supplied to the phase offset monitor. Evidently other repetitive digital signal patterns are also possible. The principle is that the serial data stream should resemble the transmit clock, and depending on the ratio between the transmit clock frequency and the transmit data rate, a respective number of equal bits should be transmitted in the respective digital signal pattern.

To test the deserializer circuit arrangement, a three-stage test process is proposed in one embodiment of the present invention. Again, the main goal is to locate bit error rate causes, and the test deals with the main causes for bit errors sequentially.

Firstly, in the same way as in the test of the serializer circuit device, the quality of a multiphase clock signal of the deserializer circuit arrangement can be assessed by detecting a phase offset between two clock phases of the multiphase clock signal using a phase offset monitor of the type previously described. This helps to check the local clock integrity by checking the multiphase quadrature. The receiver typically uses a four-phases clock signal. The four phases could be routed directly from the phase control circuit (PLL), or they could be locally generated at the receiver itself (for instance by using a delay locked loop (DLL)) to lock onto the PLL routed clock. Proper quadrature (90° phase offset) is a must to guarantee that the samplers are sensing the center of the data eye.

In addition, it is proposed to assess the quality of the data eye sampled during data recovery by the deserializer circuit arrangement, where here the deserializer circuit arrangement receives as an input signal a clock phase signal which can be a clock phase of the multiphase clock signal. This input signal is then sampled with a constant clock phase of the same frequency that can also be a clock phase of the multiphase clock signal, and the data word obtained by sampling is analysed. The phase of the clock phase signal supplied as the input signal is changed to detect and evaluate a transition in the data word obtained by sampling from a first bit pattern to a second bit pattern. As the clock phase signal supplied as the input signal and the clock phase signal used for sampling this are two clock phases originally offset by 90° of the multiphase clock signal (in a fully differential design, i.e. quadrature required), the first bit pattern corresponds to a sequence of bits with alternately a first binary value and a second deviating therefrom, while the second bit pattern is inverted to the first bit pattern. To assess the quality of the data eye, the number of intermediate values of the data word between the data word with the first bit pattern and the data word with the second bit pattern can be analysed. Around the data eye transition point, the samplers may sense any value. Therefore, the transition between those defined patterns correspond to a number of “intermediate” values. The closer the data eye, the bigger is the transition between both patterns and consequently the larger is the number of intermediate values.

Finally, to test the deserializer circuit arrangement, in one embodiment of the invention it is proposed to assess the quality of the clock recovering by the deserializer circuit arrangement, where it is tested to what extent the clock signal recovered by the deserializer circuit arrangement tracks a change in the clock signal of the serial datastream supplied. For this, the deserializer circuit arrangement again receives as an input signal a clock phase signal, which can be a clock phase of the multiphase clock signal. The clock signal then recovered from this by the deserializer circuit arrangement is compared with the clock phase signal supplied as the input signal, where the comparison takes place by detecting a phase offset between the clock phase signal supplied as an input signal and the clock signal recovered from this by the deserializer circuit arrangement. A phase offset monitor of the type described above can be used for this, although other known phase offset monitor approaches may be used as well. During the test of the deserializer circuit arrangement, the phase of the clock phase signal supplied as an input signal can be varied in steps or continuously to establish whether the phase of the recovered clock signal reconstructs accordingly the phase change of the clock phase signal supplied as the input signal.

One embodiment of the present invention is suitable for testing SERDES circuit arrangements in high speed communication modules, and in high speed transceiver modules with a data rate in the Gigabit range. The present invention is not, however, restricted to this area of application but can be used for testing SERDES circuit arrangements in any applications.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a simplified block circuit diagram of a transceiver module with serializer and deserializer circuit arrangements to be tested according to the invention, which can be structured according to FIGS. 2 and 3.

FIG. 2 illustrates a simplified block circuit diagram of a device for testing a serializer circuit arrangement according to a preferred embodiment of the present invention.

FIG. 3 illustrates a simplified block circuit diagram of a device for testing a deserializer circuit arrangement according to a preferred embodiment of the present invention.

FIG. 4 illustrates a view to explain a test implemented according to FIG. 3 to assess the quality of a data eye sampled by the deserializer circuit arrangement.

### DETAILED DESCRIPTION

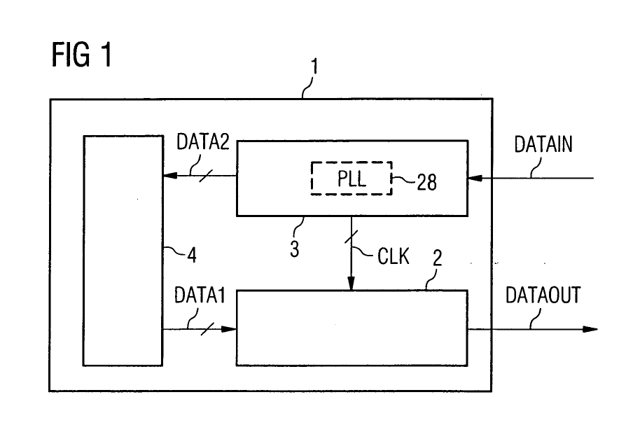

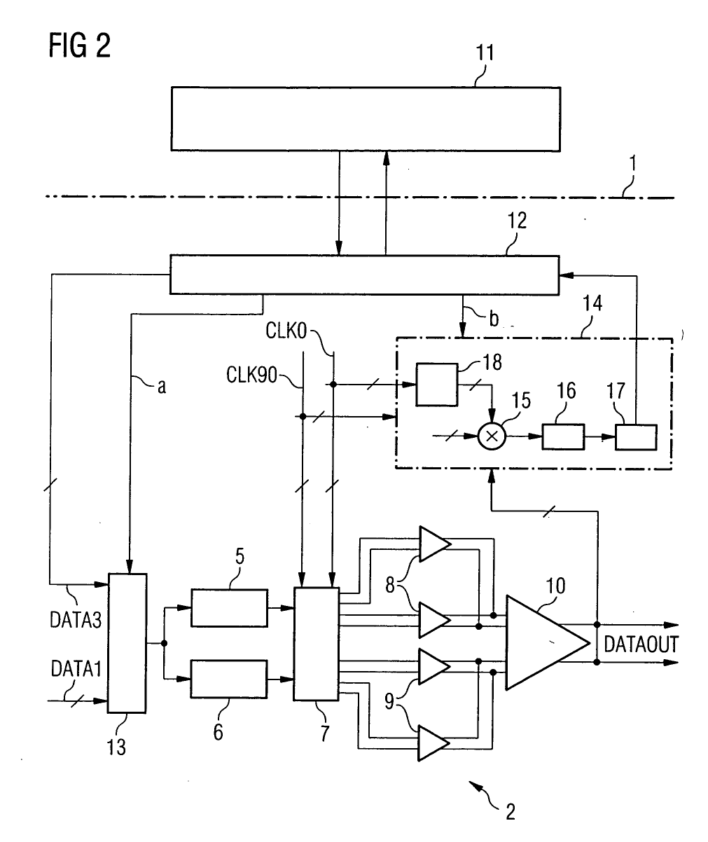

FIG. 2 illustrates a serializer circuit arrangement 2 as can be implemented, for example, in a transceiver module 1 of the type illustrated in FIG. 1. The serializer circuit arrangement 2 receives a parallel digital datastream DATA1 and multiplexes it into a serial datastream DATAOUT which is output via output connections of the transceiver module 1 (see FIG. 1). To this end, the parallel datastream 1 is split into even and uneven bit positions and supplied either to a multiplexer 5 or to a multiplexer 6. In one embodiment, the two multiplexers can be 5:1 multiplexers (the multiplexer ratio depends on the circuit configuration, that is, full rate, half rate or quarter rate system, etc.). The output signals of the two multiplexers 5,6 are supplied to an edge detection driver 7 which, using a multiphase clock signal of which FIG. 2 shows illustrates clock phase signals CLK0 and CLK90, passes the data through differential amplifiers 8, 9, which a clock controlled, to a driver 10 via which finally the serial datastream DATAOUT is output. The function of components 5-10 is in accordance with standard components of a serializer circuit arrangement.

The individual signals of the serializer circuit arrangement 2 are transferred differentially on the serial side, while on the parallel side they are transmitted in “single ended” operation.

As already explained above, the serializer circuit arrangement 2 uses a multiphase clock signal (see multiphase clock signal CLK of FIG. 1). This can be a four-phase clock signal, that is, a clock signal with four clock phases with equidistant phase difference. This multiphase clock signal can be generated at any point within the transceiver module and may originate from a phase locked loop (PLL) of a deserializer circuit arrangement present on the same transceiver module (see view in FIG. 1). The PLL locks onto the recovered data. The four clock phases or clock phase signals of the multiphase clock signal CLK can be referred to as CLK0, CLK90, CLK180 and CLK270 in relation to their phase position. The different clock phase signals may be transmitted differentially, where the clock phase signal CLK0 is transmitted differentially with the clock phase signal CLK180 and the clock phase signal CLK90 differentially with the clock phase signal CLK270. This is the reason why FIG. 2 illustrates only the clock phase signals CLK0 and CLK90, when in fact each of these two clock phase signals implies a further clock phase signal with a phase difference of 180°. All clock phase signals of the multiphase clock signal have the same frequency, which depends on the clock rate of the datastream DATAIN received by the transceiver module 1 (see again FIG. 1).

For proper operation of the serializer circuit arrangement 2, it is of considerable importance that the phase difference between the individual clock phases of the multiphase clock signal is retained as precisely as possible, as otherwise a faulty bit could be transmitted.

To test the quality of the multiphase clock signal in the serializer circuit arrangement 2 shown in FIG. 2, a phase offset monitor is provided which, according to the embodiment shown, comprises a mixer 15, a subsequent low pass filter 16 and a voltage/current converter 17. The two clock phase signals CLK0 and CLK90 of the multiphase clock signal are supplied to the phase offset monitor 14, and in one embodiment the mixer 15 which mixes these two clock phase signals transmitted differentially, so that at the output of the low pass filter 16 a direct voltage occurs that is proportional to a phase offset between the mixed clock phase signals CLK0 and CLK90. By increasing or reducing the phase offset between these two clock phase signals CLK0 and CLK90, the direct voltage at the output of the low pass filter 16 rises or falls accordingly. This direct voltage is supplied to the voltage/current converter 17, which then draws from an energy supply source (not shown) a current proportional to this direct voltage.

The current drawn from the voltage/current converter 17 is monitored via a digital test interface 12 of the transceiver module 1 by an external test device 11 which also controls the entire test sequence, that is, the external test device 11 can, by monitoring the output signal of the voltage/current converter 17 or phase offset monitor 14, monitor the phase position between the clock phase signals CLK0 and CLK90. It is clear from FIG. 2 that for this test only the phase offset monitor 14 need be integrated, where this phase offset monitor 14 can be used not only for testing the multiphase clock signal but also for other test purposes which will be explained further below.

In addition, for the serializer circuit arrangement 2 shown in FIG. 2, a test is also implemented that tests the ability of the serializer circuit arrangement to transmit a prespecified repetitive digital signal pattern. This data stream should resemble the transmit clock coming from the PLL incorporated into the deserializer circuit arrangement 3. The waveform of this data stream should look like the waveform of the clock coming from the PLL. One goal of this test is to assess basic implementation and risk of timing errors.

This test is performed in that the digital circuit core 4 or the external test device 11 supplies to the serializer circuit arrangement 2 via the digital test interface 12 the preset repetitive digital signal pattern DATA3. To this end, at the input of the serializer circuit arrangement 2 is provided a further multiplexer 18, by control of which it is possible to switch the external test device 11 between a mode in which the datastream DATA1 is supplied as the input datastream and a mode in which the datastream DATA3 is supplied as the input datastream. The functionality of the multiplexer 18 can also be carried out by the digital circuit core 4. In the simplest case, the prespecified repetitive digital signal pattern DATA3 is an “010101 . . . ”bit pattern, that is, the even input lines of the serializer circuit arrangement 2 are set to the binary value “1” while the uneven input lines are set to the binary value “0”. On supply of this repetitive digital signal pattern, the serializer circuit arrangement 2 would generate as a serial output datastream DATAOUT a datastream which switches continuously between “0” and “1”, that is, the serializer circuit arrangement 2 would generate the output datastream DATAOUT in the form of a clock signal, where the frequency of this clock signal corresponds to the frequency of the multiphase clock signal. In this case the output datastream DATAOUT and the clock phase signal CLK0 (and also any other clock phase signal of the multiphase clock signal) have a constant phase difference so that the phase offset monitor 14 shown in FIG. 2 can also be used to check whether the repetitive digital data signal pattern supplied has been correctly transmitted.

To this end, the external test device 11 (automatic test equipment, ATE), via the digital test interface 12, which can comprise a multiplicity of digital registers (which are already part of the design and also provided for the normal operation mode in order to control the function of every single analog block provided in the SERDES design), controls the phase offset monitor 14 such that using the mixer 15 of the phase offset monitor 14 the clock phase signal CLK0 is mixed no longer with the clock phase signal CLK90, but with the datastream DATAOUT. If the serializer circuit arrangement 2 were to transmit a faulty bit, a corresponding change would occur in the frequency spectrum at the output of mixer 15 which would lead to a change in the direct voltage at the output of the low pass filter 16 and consequently also to a corresponding deviation and in particular a prefix change in the output signal of the voltage/current converter 17. The external test device 11 can thus, again by analysis of the output signal of the phase offset monitor 14, assess the ability of the serializer circuit arrangement 2 to transmit a prespecified repetitive digital signal pattern.

As has previously been explained, the repetitive digital signal pattern DATA3 supplied for this test is in one case an “010101 . . . ” bit sequence. In principle, however, any other regular or repetitive signal pattern can be used depending on the ratio between the system data rate and the PLL frequency (see above), where for example on the use of an “00110011 . . . ” bit sequence, the clock phase signal CLK0 would have to be divided by the division factor 2 before mixing with serial datastream DATAOUT of the serializer circuit arrangement 2. To this end, FIG. 2 provides a corresponding divisor 18 in the phase offset monitor 14. In the same way, the divisor 18 must have a division factor of 1/x if as a repetitive digital signal pattern a bit sequence is used that comprises alternately a sequence of x bits with binary value 0 and a sequence of x bits with the binary value of “1”.

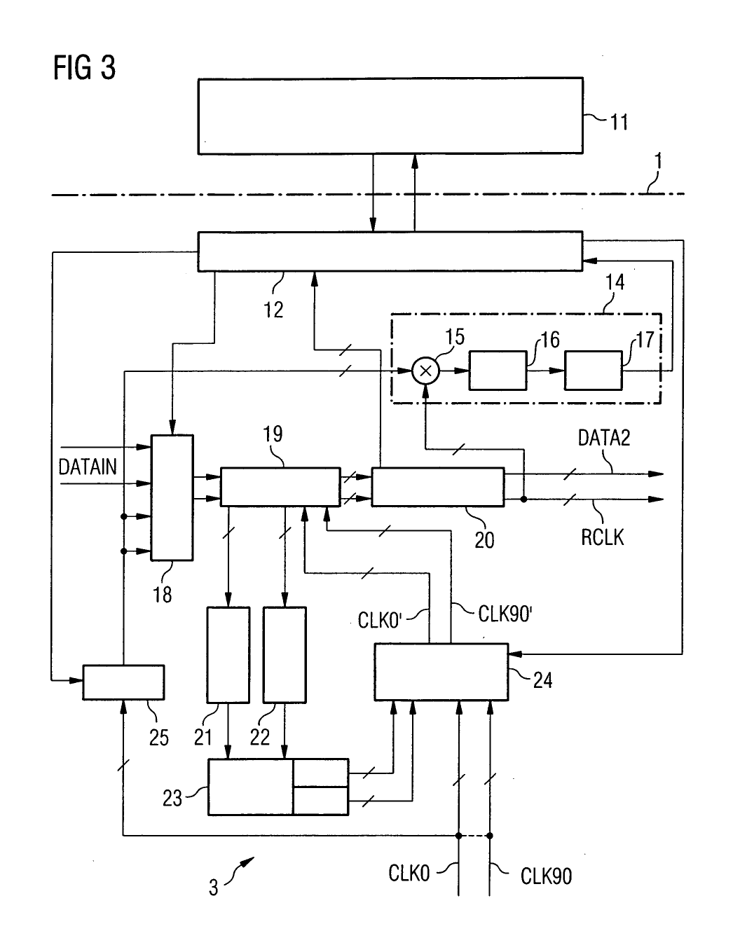

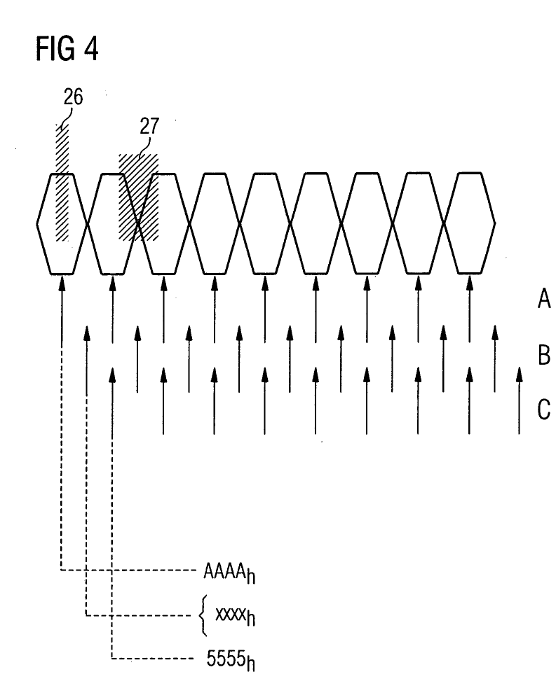

With reference to FIG. 3 and FIG. 4, the test sequence for testing a deserializer circuit arrangement will now be explained in detail.

FIG. 3 illustrates a block circuit diagram of a deserializer circuit arrangement 3 as can be used in particular in the transceiver module 1 illustrated in FIG. 1.

The essential function of the deserializer circuit arrangement 3 is to recover the clock signal from a serial datastream DATAIN supplied and using the recovered clock signal, to sample the datastream with the multiphase clock signal provided by the PLL depending on the recovered clock signal such that the originally transmitted data can be recovered from this. The recovered data are then demultiplexed to a parallel datastream DATA2. As with the serializer circuit arrangement 2 illustrated in FIG. 2, with the deserializer circuit arrangement 3 illustrated in FIG. 3 the data transmission takes place differentially on the serial side and in single ended mode on the parallel side.

To implement the function previously described, the deserializer circuit arrangement 3 comprises a phase detector 19, where the phase detector 19 receives clock phase signals CLK0′ and CLK90′ which in turn can be derived via phase interpolators from the clock phase signals CLK0 or CLK90 of the multiphase clock signal CKL coming from the PLL. The phase detector 19 samples the input datastream DATAIN with the clock phase signals CLK0′ and CLK90′, where the sampling values obtained which are too late and consequently obtained after a data eye are supplied via demultiplexer 21 while the sampling values which are too early before a data eye are supplied via demultiplexer 22. The output signals of the two demultiplexers 21 and 22 are supplied to a control device 23 with digital registers, where depending on the output signals of the two demultiplexers 21, 22 corresponding adjustment signals can be generated for the phase interpolators 24 in order to adjust the phase position of the sampling phases CKL0′ and CLK90′ accordingly. Thus, the phase detector 19 senses serial data transition events, compares the position of these events with local clock rising edges by statistical analysis of the number of early and late events, and processes this information for re-tuning the phase interpolators 24 to align the serial data transition events with rising edges of the local clock. By doing so, it also recovers the clock from the incoming data DATAIN and sends it to the PLL. In the adjusted state of the phase control circuit implemented in this way, the phase detector 19 supplies both the recovered clock signal and the data recovered from the input datastream DATAIN, where the corresponding information is then output via a further multiplexer 20, that is, the recovered data are demultiplexed to the parallel datastream DATA2. The demultiplexers 21 and 22 can be 1:4 demultiplexers, while the demultiplexer 20 is preferably a 2:10 demultiplexer. The demultiplexer ratio depends on the PLL frequency to data rate ratio. FIG. 3 also illustrates the clock signal RCLK recovered by the deserializer circuit arrangement 3. The function method previously described and the corresponding circuit components are less relevant to the present invention so these need not be discussed further at this point.

Like the serializer circuit arrangement 2, the deserializer circuit arrangement 3 uses the multiphase clock signal with the four differentially transferred clock phase signals of which FIG. 3 illustrates the clock phase signals CLK0 and CLK90. These clock phase signals come from the PLL and are derived from the recovered clock signal RCLK and adjusted accordingly to the phase of the recovered clock signal RCLK.

For operation of the deserializer circuit arrangement 3, the phase difference between the individual clock phases of the multiphase clock signal should be maintained as precise as possible, in order to avoid receiving a faulty bit. The quality of the multiphase clock signal can consequently be checked in the same way as in the serializer circuit arrangement 2 using a phase offset monitor 14 which mixes the clock phase signals CLK0 and CLK90 in order thus to be able to evaluate the phase offset between the two clock phase signals. The general test sequence is identical to the test of the multiphase clock signal in the serializer circuit arrangement 2 illustrated in FIG. 2.

A further test of the deserializer circuit arrangement 3 provides an assessment of the quality of the data eye sampled by the deserializer circuit arrangement 3. To this end, the deserializer circuit arrangement 3 is supplemented by a multiplexer 18 and a programmable phase delay element 25 (which could also be implemented within a DLL if a DLL were used to generate the four clock phases required to sample the data). The multiplexer 18, in the same way as the multiplexer 13 illustrated in FIG. 2, serves to supply the deserializer circuit arrangement 3 in test mode with an input signal different from the data input current stream DATAIN. In particular, this input signal in the data eye test is a clock or clock phase signal, where here the clock phase signal CLK0 can be used which is thus supplied via the programmable phase delay element 25 and the multiplexer 18 to the input of the phase detector 19. In this test mode, the function of the phase control circuit of the deserializer circuit arrangement 3 is frozen, where as illustrated in FIG. 3 this can be achieved by applying a corresponding control signal from the external test device 11 via the digital test interface 12 to the phase interpolators 24 so that the clock phase signals CLK0′ and CLK90′ have a constant phase which is proportional to the phase of the clock phase signals CLK0 to CLK90. The sampler integrated in the phase detector 19 thus samples the clock phase signal from the programmable phase delay element 25, supplied as an input signal, with constant phase and consequently at constant points. In the output state, the run time delay of the programmable phase delay element 25 and phase interpolators 24 is selected such that the propagation delay of the clock signal CLK0 and CLK90 via the phase interpolators 24 to the sampler of the phase detector 19 is essentially identical to the run time of the clock phase signal CLK0 via the programmable phase delay element 25 and the multiplexer 18 to the input of the phase detector 19.

The data supplied in this test mode to the phase detector 19 for sampling, which correspond to the differential clock phase signal CLK0, thus act on the phase detector 19 like an “010101 . . . ” bit pattern. As the run time delay of the clock phase signal CLK0 via the programmable phase delay element 25 is at least to some extent, identical to the propagation delay of the phase interpolators 24, the sampler of the phase detector 19 samples the incoming data immediately in the center of the data eye concerned so that the resulting sampling values correspond to a data word with a hexadecimal value AAAAₕ or a data word with a hexadecimal 5555ₕ.

This will now be explained in more detail with reference to FIG. 4, where in FIG. 4 illustrates at the top the input datastream based on the clock phase signal CKL0 of the phase detector 19. The line marked A shows that this input datastream is always sampled in the middle of the data eye concerned, where depending on synchronisation the data obtained by sampling is detected binary as “1010 . . . ” that is, hexadecimally as “A”. In the line marked C of FIG. 4 however, because of the different synchronisation, the data is still sampled in the middle of the data eye but the data obtained by sampling is detected binary as “0101 . . . ” i.e. hexadecimally as “5”. In the middle of the data eye, i.e. in an area marked 26 in FIG. 4, the data can be reconstructed clearly identifiably and reliably. In the transition area 27 between two data eyes however the data cannot be reconstructed reliably and because of the uncertainty present there is a risk of bit errors.

If the phase delay of the programmable phase delay element 25 is varied, this leads to a corresponding shift in the relative position of the sampling point in the phase detector 19 in relation to the supplied input datastream. In particular by shifting the sampling point within each incoming data eye either first a binary “0” and then a binary “1” or first a binary “I” and then a binary “0” are read. In the sampled values, stored in digital output registers of block 20, of the reconstructed data word concerned, thus gradually a change can be detected from the data word “AAAAₕ” to the data word “5555ₕ”, where between these two limit values on shifts in the sampling position i.e. on changes in phase delay by the programmable phase delay element 25, the data word obtained by sampling can in principle assume any intermediate value, which is indicated in FIG. 4 in line B with the value “xxxxₕ” of the sampled data word.

It is evident that the quality of the data eye increases the lower the number of intermediate values between the limit values “AAAAₕ” and “5555ₕ” of the data word obtained by sampling, since the opening of the data eye increases as the number of intermediate values decreases.

The test device 11 can thus test the quality of the data eye of the deserializer circuit arrangement 3 in that continuously or in steps the phase delay of the programmable phase delay element 25 is changed via the digital test interface 12 and then by evaluating the sampled values stored in the digital registers of the control device 23, the transition of the corresponding data word from “AAAAₕ” to “5555ₕ” (or vice versa) is monitored.

The external test device 11 can assess the quality of the data eye in particular in that by changing the phase delay of the programmable phase delay element 25, it detects and evaluates the number of different values of the data word obtained by sampling the phase-delayed clock phase signal CLK0, supplied as an input signal, during the transition from the value “AAAAₕ” to the value “5555ₕ” (or vice versa).

As well as the test described above of the quality of the multiphase clock signal and the data eye of the deserializer circuit arrangement 3, in addition a test is provided of the clock recovery by the deserializer circuit arrangement 3. The ability of the recovered clock RCLK to reliably follow or track each phase variation of the supplied input datastream is an important indicator of the quality of the implemented deserializer circuit arrangement.

To test the clock recovery, the deserializer circuit arrangement 3 again receives as an input signal via the multiplexer 18 a clock phase signal, where in this case for example the input signal can be the clock phase signal CLK90 which in turn is supplied via the programmable phase delay element 25 to the deserializer circuit arrangement 3.

In the ideal state, the phase position of the recovered clock signal RCLK, because of the function of the phase control circuit of the deserializer circuit arrangement 3, in the regulated state of the phase control circuit would be adjusted to the phase position of the clock phase signal CLK90 supplied via the programmable phase delay element 25, as the clock phase signal CLK90 supplied as the input signal acts on the deserializer circuit arrangement 3 as a “101010 . . . ” datastream.

By comparing the clock phase signal CLK90 supplied as an input signal with the clock signal RCLK recovered by the deserializer circuit arrangement 3, it can be monitored whether the recovered clock signal properly follows or tracks any phase change in the incoming data, which for this test is locally generated using the PLL output and the programmable phase delay element 25. Here again—as shown in FIG. 3—the phase offset monitor 14 of the type previously described is used, where the mixer 15 of the phase offset monitor 14 mixes the clock phase signal CLK90 supplied as an input signal for this test and phase-delayed by the programmable phase delay element 25 with the clock signal RCLK recovered from this by the deserializer circuit arrangement 3. The output signal of the phase offset monitor 14 is again evaluated by the external test device 11 via the digital test interface 12. This type of phase offset monitor 14 uses a voltage/current converter (see above). The supply current should be “almost” a quiescent current. The power supply is provided by the external test device 11, and therefore the external test device 11 can sense the supply current variations to inform about the test results. Of course, other possibilities exist to encode the test results.

To test the reliability of the clock recovery of the deserializer circuit arrangement 3, not only is the clock phase signal CLK90 supplied as an input signal to the deserializer circuit arrangement 3, but the external test device 11 via the digital test interface 12 controls the programmable phase delay element 25 such that the phase delay of the clock phase signal CLK90 supplied as an input signal is changed continuously or in steps. For each new phase position of the clock phase signal CLK90 supplied as an input signal, correspondingly the phase offset is detected to the clock signal RCLK recovered from this by analysis of the output signal of the phase offset monitor 14. In the ideal state, the relative phase offset between the signals supplied to the phase offset monitor 14 would remain constant irrespective of the phase delay of the programmable phase delay element 25, i.e. irrespective of the phase delay of the programmable phase element 25 no change would be discernible in the direct voltage at the output of the low pass filter 16. In this way, the external test device 11, by changing the phase delay of the programmable phase delay element 25, can reliably test the ability of the deserializer circuit arrangement 3 to correctly reconstruct a clock change of the datastream supplied to it.

Although exemplary embodiments of the invention are described above in detail, this does not limit the scope of the invention, which can be practiced in a variety of embodiments.

1. A process for testing a serializer circuit arrangement comprising:
using the serializer circuit arrangement to convert a parallel datastream into a serial datastream by using a multiphase clock signal; and
detecting a phase offset between two clock phases of the multiphase clock signal is detected in order to assess the quality of the multiphase clock signal.

2. The process according to claim 1, wherein to detect the phase offset between the two clock phases corresponding clock phase signals are mixed, a resulting output signal being evaluated to assess the quality of the multiphase clock signal.

3. The process according to claim 2, wherein the output signal resulting from the mixing of the clock phase signals is low pass filtered before being evaluated to assess the quality of the multiphase clock signal.

4. The process according to claim 2, wherein the output signal resulting from the mixing of the clock phase signals is subjected to a voltage/current conversion before being evaluated to assess the quality of the multiphase clock signal.

5. The process for testing a serializer circuit arrangement wherein the serializer circuit arrangement is designed for converting a parallel datastream into a serial datastream by the use of a multiphase clock signal, wherein the ability of the serializer circuit arrangement to transmit a prespecified repetitive digital signal pattern is assessed in that the specified repetitive digital signal pattern is supplied to the serializer circuit arrangement and a phase offset between a phase of a resulting serial datastream of the serializer circuit arrangement and a clock phase of the multiphase clock signal is detected.

6. The process according to claim 5, wherein a prespecified repetitive digital signal pattern comprises a repetitive bit sequence of x bits with a first logic value and x bits with a different second logic value, wherein the phase offset between the serial datastream and a clock phase signal corresponding to the clock phase and divided by a division factor 1/x is detected, with x=1, 2, 3, . . .

7. The process according to claim 5, wherein the serial datastream resulting from the prespecified repetitive digital signal pattern of the serializer circuit arrangement is mixed with a clock phase signal corresponding to the clock phase of a multiphase clock signal and the resulting output signal is evaluated.

8. The process according to claim 7, wherein the output signal resulting from the mixing of the serial datastream and the clock phase signal is low pass filtered before being evaluated.

9. The process according to claim 7, wherein the output signal resulting from the mixing of the serial datastream and the clock phase signal is subjected to a voltage/current conversion before being evaluated.

10. The process according to claim 5, wherein the multiphase clock signal has several clock phases with an equidistant phase difference.

11. The process according to claim 10, wherein the clock phase signals corresponding to several clock phases of the multiphase clock signal are supplied differentially to the serializer circuit arrangement.

12. The process according to claim 5, wherein the multiphase clock signal comprises several clock phase signals of different phase but with the same frequency.

13. The process according to claim 5, wherein the several parallel datastreams are supplied to the serializer circuit arrangement in single ended mode while the serial datastream is transmitted differentially.

14. The process according to claim 5, wherein the process for testing the serializer circuit arrangement is carried out at wafer level of the serializer circuit arrangement via connections which are not accessible at package level of the serializer circuit arrangement.

15. The process according to claim 5, wherein the process for testing the serializer circuit arrangement is carried out via a digital test interface between the serializer circuit arrangement and an external test device to control the test process.

16. The process according to claim 5, wherein the process is used to test a serializer circuit arrangement of a high speed communication module.

17. A device for testing a serializer circuit arrangement, where the serializer circuit arrangement is designed for converting a parallel datastream into a serial datastream by the use of a multiphase clock signal, the device comprising:
phase offset detection means for detecting a phase offset between two clock phases of the multiphase clock signal; and
evaluation means for evaluating the phase offset detected by the phase offset detection means in order to assess depending thereon the quality of the multiphase clock signal.

18. The device according to claim 17, wherein the phase offset detection means comprise a mixing device for mixing clock phase signals corresponding to the two clock phases, wherein the evaluation means are designed to evaluate an output signal generated by the mixer device as a function thereof.

19. The device according to claim 18, wherein the evaluation means comprise a low pass filter device for low pass filtration of the output signal from the mixer device.

20. A device according to claim 18, wherein the phase offset detection means comprise a voltage/current conversion device for voltage/current conversion of the output signal of the mixer device.

21. A device for testing a serializer circuit arrangement, wherein the serializer circuit arrangement is designed to convert a parallel datastream into a serial datastream by using a multiphase clock signal, wherein evaluation means are provided which are designed such that by supplying a prespecified repetitive digital signal pattern to the serializer circuit arrangement, by evaluating the resulting serial datastream of the serializer circuit arrangement, said means assess the ability of the serializer circuit arrangement to transmit the prespecified repetitive digital signal pattern, and that phase offset detection means are provided to detect a phase offset between a phase of the serial datastream resulting from the prespecified repetitive digital signal pattern of the serializer circuit arrangement and a clock phase of the multiphase clock signal, wherein the evaluation means assess the ability of the serializer circuit arrangement to transmit the prespecified repetitive digital signal pattern by evaluation of the phase offset detected by the phase offset detection means.

22. The device according to claim 21, wherein the evaluation means are designed such that they supply to the serializer circuit arrangement the prespecified repetitive digital signal pattern with a repetitive bit sequence of x bits with a first logic value, and x bits with a different second logic value, wherein a clock phase signal corresponding to a clock phase of the multiphase clock signal is passed via a divisor with a division factor 1/x and the phase offset detection means are designed to detect the phase offset between the phase of the serial datastream of the serializer circuit arrangement and a phase of an output signal output by divisor, with x=1, 2, 3, . . .

23. The device according to claim 21, wherein the phase offset detection means comprise a mixing device for mixing a clock phase signal, corresponding to the clock phase of the multiphase clock signal, with the serial datastream, wherein the evaluation means are designed such that they evaluate an output signal generated dependent thereon by the mixer device.

24. The device according to claim 23, wherein the phase offset detection means comprise a low pass filter device for low pass filtration of the output signal of the mixer device.

25. The device according to claim 23, wherein the phase offset detection means comprise a voltage/current converter device to subject the output signal of the mixer device to a voltage/current conversion.

26. A process for testing a deserializer circuit arrangement wherein the deserializer circuit arrangement is designed for converting a serial datastream into a parallel datastream by use of a multiphase clock signal, wherein a phase offset between the two clock phases of the multiphase clock signal is detected in order to assess as a function thereof the quality of the multiphase clock signal.

27. The process according to claim 26, wherein the clock phase signals corresponding to the two clock phases are mixed and a resulting output signal is evaluated to assess the quality of the multiphase phase clock signal.

28. The process according to claim 27, wherein the output signal resulting from the mixing of the clock phase signals is low pass filtered before being evaluated to assess the quality of the multiphase clock signal.

29. The process according to claim 28, wherein the output signal resulting from the mixing of the clock phase signals is subjected to a voltage/current conversion before being evaluated to assess the quality of the multiphase clock signal.

30. A process for testing a deserializer circuit arrangement wherein the deserializer circuit arrangement is designed to convert a serial datastream into a parallel datastream, and wherein the deserializer circuit arrangement is designed for clock and data recovery from the serial datastream, wherein to assess the quality of a data eye sampled by the deserializer circuit arrangement for data recovery, a clock phase signal is supplied to the deserializer circuit arrangement as an input signal and is sampled with a constant clock phase of a further clock phase signal which essentially has the same frequency as the clock phase signal supplied as an input signal, wherein the phase of the clock phase signal supplied as the input signal is varied and a resulting transition in a data word obtained by sampling the clock phase signal from a first bit pattern to a second bit pattern is evaluated.

31. The process according to claim 30, wherein the clock phase signal, which is supplied to the deserializer circuit arrangement as an input signal for testing the deserializer circuit arrangement, is a clock phase signal of a multiphase clock signal, the further clock phase signal used for sampling being a different further clock phase signal of the multiphase clock signal.

32. The process according to claim 31, wherein between the clock phase signal supplied to the deserializer circuit arrangement as an input signal and the clock phase signal used for sampling there is a phase difference of 90°.

33. The process according to claim 30, wherein the first bit pattern corresponds to a sequence of bits with alternately a first logic value and a different second logic value, where the second bit pattern corresponds to a bit pattern inverted to the first bit pattern.

34. The process according to claim 30, wherein the deserializer circuit arrangement has for data and clock recovery a phase control circuit with a phase detector and a phase interpolator, wherein to test the deserializer circuit arrangement the clock phase signal supplied as an input signal is supplied to the phase detector while the clock phase used for sampling is supplied to the phase detector via the phase interpolator, and wherein the propagation delay of the clock phase signal, supplied as an input signal, to the phase detector essentially corresponds to the propagation delay of the clock phase used for sampling via the phase interpolator to the phase detector.

35. The process according to claim 34, wherein to test the quality of the data eye of the deserializer circuit arrangement, operation of the phase control circuit is frozen.

36. The process according to claim 30, wherein to assess the quality of the data eye of the deserializer circuit arrangement, a number of different values of the data word, obtained by sampling the clock phase signal supplied as an input signal during the phase change, between the first bit pattern and the second bit pattern are evaluated.

37. The process for testing a deserializer circuit arrangement, wherein the deserializer circuit arrangement is designed to convert a serial datastream into a parallel datastream, and wherein the deserializer circuit arrangement is designed for clock and data recovery from the supplied serial datastream, wherein to test the clock recovery of the deserializer circuit arrangement, a clock phase signal is supplied as an input signal to the deserializer circuit arrangement, wherein a clock signal then recovered by the deserializer circuit arrangement from the supplied clock phase signal is compared with the clock phase signal supplied in order to assess as a function thereof the clock recovery of the deserializer circuit arrangement.

38. The process according to claim 37, wherein the clock phase signal supplied to test the clock recovery of the deserializer circuit arrangement corresponds to a clock phase of a multiphase clock signal.

39. The process according to claim 37, wherein the phase of the clock phase signal supplied as an input signal to the deserializer circuit arrangement changes and the clock signal then recovered therefrom is compared with the supplied clock phase signal with the changed phase in order to assess whether the clock signal recovered by the deserializer circuit arrangement reconstructs the phase change of the supplied clock phase signal.

40. The process according to claim 37, characterised in to compare the recovered clock signal with the clock phase signal supplied to test the deserializer circuit arrangement, the clock phase signal supplied is mixed with the recovered clock signal, wherein a resulting output signal is evaluated.

41. The process according to claim 40, wherein the output signal resulting from mixing the supplied clock phase signal with the recovered clock signal is low pass filtered before being evaluated.

42. The process according to claim 40, wherein the output signal resulting from mixing the supplied clock phase signal with the recovered clock signal is subjected to a voltage/current conversion before being evaluated.

43. The process according to claim 37, wherein a multiphase clock signal with several clock phases with equidistant phase difference is supplied to the deserializer circuit arrangement.

44. The process according to claim 43, wherein the clock phase signals corresponding to the individual clock phases of the multiphase clock signal are supplied differentially to the deserializer circuit arrangement.

45. The process according to claim 43, wherein the multiphase clock signal comprises several clock phase signals with the same frequency but different phase.

46. The process according to claim 37, wherein the serial data stream is supplied differentially to the deserializer circuit arrangement while the parallel datastreams are transmitted in single ended mode by the deserializer circuit arrangement.

47. The process according to claim 37, wherein the process for testing the deserializer circuit arrangement is carried out at wafer level of the deserializer circuit arrangement via connections which are not accessible at package level of the deserializer circuit arrangement.

48. The process according to claim 37, wherein the process for testing the deserializer circuit arrangement is carried out via a digital test interface to an external test device to control the test process.

49. The process according to claim 37, wherein the process is used to test a deserializer circuit arrangement of a high speed communication module.

50. A device for testing a deserializer circuit arrangement, wherein the deserializer circuit arrangement is designed to convert a serial datastream into a parallel datastream by use of a multiphase clock signal, wherein phase offset detection means are provided to detect a phase offset between two clock phases of the multiphase clock signal, and that evaluation means are provided to assess the quality of the multiphase clock signal by evaluating the phase offset detected by the phase offset detection means.

51. The device according to claim 50, wherein the phase offset detection means comprise a mixer device for mixing clock phase signals corresponding to the clock phases, wherein the evaluation means are designed to evaluate an output signal generated by the mixer device.

52. The device according to claim 51, wherein the phase offset detection means comprise a low pass filter device for low pass filtration of the output signal generated by the mixer device.

53. The device according to claim 51, wherein the phase offset detection means comprise a voltage/current conversion device for voltage/current conversion of the output signal of the mixer device.

54. The device for testing a deserializer circuit arrangement, wherein the deserializer circuit arrangement is designed to convert a serial datastream into a parallel datastream, and wherein the deserializer circuit arrangement is designed for clock and data recovery from the serial datastream supplied, wherein evaluation means are provided which are designed so that to test the quality of a data eye, sampled on data recovery, of the deserializer circuit arrangement said means supply as an input signal a clock phase signal and cause the deserializer circuit arrangement to sample the clock phase signal supplied as an input signal with a constant clock phase of a further clock phase signal, which has essentially the same frequency as the clock phase signal supplied as an input signal, for data recovery from the clock phase signal supplied as the input signal, wherein the evaluation means are designed such that they vary the phase of the clock phase signal supplied as an input signal and evaluate a resulting transition in a data word, obtained on sampling with the constant clock phase, from a first bit pattern to a second bit pattern.

55. The device according to claim 54, wherein the clock phase signal supplied as an input signal corresponds to a clock phase of a multiphase clock signal, and that the constant clock phase used for sampling the input signal corresponds to a further clock phase of the multiphase clock signal which differs from the clock phase signal supplied as the input signal.

56. The device according to claim 55, wherein the clock phase signal supplied as an input signal and the clock phase used for sampling have a phase difference of 90°.

57. The device according to claim 54, wherein the first bit pattern corresponds to a sequence of bits with alternately a first and a different second logic value, wherein the second bit pattern corresponds to the bit pattern inverted to the first.

58. The device according to claim 54, wherein digital registers are provided to store the data words obtained by sampling the clock phase signal supplied as an input signal.

59. The device according to claim 54, wherein the clock phase signal supplied as an input signal is supplied to the deserializer circuit arrangement via means for changing the phase of this clock phase signal, and that the evaluation means are designed such that they control these means accordingly to vary the phase of the clock phase signal supplied as an input signal.

60. The device according to claim 59, wherein the deserializer circuit arrangement has a phase control circuit with a phase detector and a phase interpolator, wherein the clock phase signal supplied as an input signal is supplied to the phase detector via the means for varying the phase of the clock phase signal while the further clock phase signal corresponding to the clock phase used for sampling is supplied to the phase detector via the phase interpolator, and that in a starting state of the device a propagation delay of the clock phase signal used as an input signal to the phase detector via the means for varying the phase essentially corresponds to a propagation delay of the clock phase signal used for sampling to the phase detector via the phase interpolator.

61. The device according to claim 60, wherein the evaluation means are designed such that to test the quality of the sampled data eye of the deserializer circuit arrangement, they freeze the operation of the phase control circuit.

62. The device according to claim 54, wherein the evaluation means are designed such that to test the quality of the sampled data eye of the deserializer circuit arrangement, they evaluate a number of different values during transition of the data word obtained by sampling the clock phase signal supplied as an input signal from the first bit pattern to the second bit pattern.

63. A device for testing a deserializer circuit arrangement, wherein the deserializer circuit arrangement is designed to convert a serial datastream into a parallel datastream and wherein the deserializer circuit arrangement is designed for clock and data recovery from the serial datastream supplied, wherein evaluation means are provided which are designed such that to test the clock recovery of the deserializer circuit arrangement they supply a clock phase signal as an input signal, and that phase offset detection means are provided to detect a phase offset between the clock phase signal supplied as an input signal and a clock signal then recovered by the deserializer circuit arrangement, where the evaluation means are designed to evaluate the phase offset detected by the phase offset detection means.

64. The device according to claim 63, wherein the clock phase signal supplied as an input signal to test the deserializer circuit arrangement corresponds to a clock phase of a multiphase clock signal supplied to the deserializer circuit arrangement.

65. The device according to claim 63, wherein the clock phase signal is supplied to the deserializer circuit arrangement via means for varying the phase of the clock phase signal, and that the evaluation means control these means for varying the phase of the clock phase signal and evaluate the phase offset then detected by the phase offset detection means between the clock phase signal with the varied phase and the clock signal recovered by the deserializer circuit arrangement.

66. The device according to claim 63, wherein the phase offset detection means have a mixer device for mixing the clock phase signal supplied as input signal with the clock signal then recovered by the deserializer circuit arrangement, where the evaluation means are designed to evaluate an output signal of the mixer device.

67. The device according to claim 66, wherein the phase offset detection means comprise a low pass filter device for low pass filtration of the output signal from the mixer device.

68. The device according to claim 66, wherein the phase offset detection means comprise a voltage/current conversion device for voltage/current conversion of the output signal from the mixer device.

69. The process according to claim 1, wherein the multiphase clock signal has several clock phases with an equidistant phase difference.

70. The process according to claim 1, wherein the multiphase clock signal comprises several clock phase signals of different phase but with the same frequency.

71. The process according to claim 1, wherein the several parallel datastreams are supplied to the serializer circuit arrangement in single ended mode while the serial datastream is transmitted differentially.

72. The process according to claim 1, wherein the process for testing the serializer circuit arrangement is carried out at wafer level of the serializer circuit arrangement via connections which are not accessible at package level of the serializer circuit arrangement.

73. The process according to claim 1, wherein the process for testing the serializer circuit arrangement is carried out via a digital test interface between the serializer circuit arrangement and an external test device to control the test process.

74. The process according to claim 1, wherein the process is used to test a serializer circuit arrangement of a high speed communication module.

75. The process according to claim 27, wherein the output signal resulting from the mixing of the clock phase signals is subjected to a voltage/current conversion before being evaluated to assess the quality of the multiphase clock signal.

76. The process according to claim 30, wherein a multiphase clock signal with several clock phases with equidistant phase difference is supplied to the deserializer circuit arrangement.

77. The process according to claim 26, wherein a multiphase clock signal with several clock phases with equidistant phase difference is supplied to the deserializer circuit arrangement.

78. The process according to claim 30, wherein the serial data stream is supplied differentially to the deserializer circuit arrangement while the parallel datastreams are transmitted in single ended mode by the deserializer circuit arrangement.

79. The process according to claim 30, wherein the process for testing the deserializer circuit arrangement is carried out at wafer level of the deserializer circuit arrangement via connections which are not accessible at package level of the deserializer circuit arrangement.

80. The process according to claim 30, wherein the process for testing the deserializer circuit arrangement is carried out via a digital test interface to an external test device to control the test process.

81. The process according to claim 30, wherein the process is used to test a deserializer circuit arrangement of a high speed communication module.

82. The process according to claim 26, wherein the serial data stream is supplied differentially to the deserializer circuit arrangement while the parallel datastreams are transmitted in single ended mode by the deserializer circuit arrangement.

83. The process according to claim 26, wherein the process for testing the deserializer circuit arrangement is carried out at wafer level of the deserializer circuit arrangement via connections which are not accessible at package level of the deserializer circuit arrangement.

84. The process according to claim 26, wherein the process for testing the deserializer circuit arrangement is carried out via a digital test interface to an external test device to control the test process.

85. The process according to claim 26, wherein the process is used to test a deserializer circuit arrangement of a high speed communication module.
